(19) United States
(12) Patent Application Publication
(10) Pub. No.: US 2003/0112100 A1
(43) Pub. Date: Jun. 19, 2003

(54) Printed circuit board radio frequency filter apparatus

(75) Inventors: Gerald D. Harron, Martensville (CA); Surinder G. Kumar, Victoria (CA)

Correspondence Address: BLAKE, CASSELS & GRAYDON, LLP, 45 O'CONNOR ST., 20TH FLOOR, OTTAWA, ON, K1P 1A4, CA

(73) Assignee: Wavecom Electronics Inc.

(21) Appl. No.: 10/015,885

(22) Filed: Dec. 17, 2001

(51) Int. Cl. H01P 1/20

(52) U.S. Cl. 333/202

(57) ABSTRACT

An RF filter includes elongate radiator elements constructed from printed circuit board (PCB) materials and using PCB fabrication techniques. The radiator elements are spacedly disposed and contained within a shielded enclosure. The filter apparatus has input and output leads exterior to the filter to pass a signal to be filtered. The filter is tuned by the shape and of the elongate radiator elements and shielded enclose and by conductive leads extending from the shielded enclosure toward the elongate radiator elements. The shape and number of the conductive lead elements may be varied to control RF coupling between radiator elements and the tuning of the filter.

### FIELD OF THE INVENTION

The present invention generally relates to filters and more particularly to radio frequency RF filter arrangements formed using printed circuit board techniques.

### BACKGROUND OF THE INVENTION

Radio frequency (RF) filter apparatus incorporating one or more radio frequency radiator elements, for example, constructed from helical wire or rod conductors to produce frequency dependent filter arrangements are known in the art. Typically, filter arrangements employing conductive rod and machined rod conductive elements form a frequency dependent resonator circuit to condition radio frequency signals passing through the filter. A general description of the construction and tuning of certain types of RF radiator resonant filter assemblies is given our issued U.S. Pat. No. 6,064,285.

Heretofore, construction of rod type RF radiator resonant filters required the supply and production of one or more rod elements machined into the form required to provide the desired filter characteristics of a resonator filter. Supply and production of the rod elements employ construction methods that have several disadvantages in the context of a printed circuit board production facility including the need to produce metal conductors of the required structural dimensions to construct and mount the rods of the filter.

Construction of RF filters in this manner has several disadvantages. The complexity and cost of producing printed circuit board assemblies could be reduced if the need for machined rods and the mounting steps consequent on use of such rods in producing an RF is eliminated. Furthermore, the cost of producing printed circuit board assemblies that include RF filters could be reduced if the need for rod forming and mounting equipment could be eliminated. Accordingly, there exists a need for implementation of resonator filters which do not require the supply of conductor rods to form the structure of an RF filter.

### SUMMARY OF THE INVENTION

The present invention provides an RF filter apparatus constructed using printed circuit board techniques and materials. In accordance with the invention, an RF filter is fabricated using the equipment, materials and production methods as used to produce a printed circuit board assembly. In accordance with the manner of construction of an RF filter using the principles of the present invention, the need to provide conductive rods to construct a resonator filter is eliminated. Moreover, with the present invention, radiator type RF filters can be produced without the need to provide equipment to form rod conductors.

The invention is characterised by an RF filter arrangement constructed from radiators fabricated from printed circuit board materials in accordance with the invention and has a radio frequency (RF) shielding enclosure bounding a volume enclosing the filter assembly. The shielding enclosure forms a single cavity eliminating the need or requirement for inner walls to form apertures to control the RF coupling between adjacent radiators.

Other characteristics of the invention include at least one elongate conductive element that is coupled to the shielding enclosure and extends inwardly into the volume bounded by the shielding enclosure. The free end of the elongate conductive element is disposed proximal to a radiator or between adjacent radiators to control the RF signal filtering effected by the radiator and the RF coupling between adjacent radiators. The shape, length, mass and positioning of the conductive elements are selected to obtain the operation of the RF filter in accordance with the characteristics desired for requirements of the application in which the filter will be incorporated.

In one of its aspects, the invention provides a radio frequency (RF) filter assembly having a conductive RF shielding means bounding a volume. At least two spacedly disposed elongate radiator elements are disposed within the volume bounded by the conductive RF shielding means. Each elongate radiator element is oriented in a common plane and is substantially parallel to another and one end of each elongate radiator element being is attached to the shielding means. An input tap line is connected at a predetermined input location to a first radiator element disposed proximal to said conductive RF shielding means. The input tap line extends outwardly through to the exterior of the conductive RF shielding means. An output tap line is connected at a predetermined output location to a second radiator element disposed proximal to the conductive RF shielding means and remote from the first radiator element. The output tap line extends through to the exterior of the conductive RF shielding means.

In another of its aspects, the invention provides, a radio frequency (RF) filter assembly comprising at least two spacedly disposed elongate radiator elements formed from double sided PCB material and includes means to electrically interconnect each side of said radiator double sided PCB material. Shielding means bounding a volume containing all said elongate radiator elements. Spacing means maintain the spaced disposition of each elongate radiator element to the other and to said shielding means. Conductor means interconnects an end of each elongate radiator element to the conductive RF shielding means. An input tap line is connected to a first radiator element at a predetermined input location and extends outwardly through to the exterior of the conductive RF shielding means. An output tap line is connected to a second radiator element remote from the first radiator element at a predetermined output location. The output tap line extends through to the exterior of the conductive RF shielding means.

These and other objects and advantages of the present invention will become apparent to those skilled in the art in the context of the present invention as described in the specification, drawings and claims herein. Referring to the drawings, like reference numerals identify like features of the invention in the several figures throughout. The preferred embodiments of the invention will now be described with reference to the drawings in which:

### BRIEF DESCRIPTION OF THE DRAWINGS

FIG. 1 is a bottom plan view of a filter and shielding apparatus constructed in accordance with the principles invention;

FIG. 2 is a top plan view of a mounted shielding can of FIG. 1;

FIG. 3 is a cross-section of the mounted shielding can of FIG. 2 taken along cutting line 3-3 including a cross section through one of the filter radiator elements;

FIG. 4 is a plan view of an alternate embodiment of a filter apparatus of the invention;

FIG. 5 is a cross-section of the radiator structure of FIG. 2 including mounted shielding apparatus and showing a filter radiator element in cross-section;

FIG. 6 is a top plan view of an alternate embodiment of a filter apparatus constructed in accordance with the principles of the invention;

FIG. 7 is a bottom plan view of the embodiment of FIG. 6;

FIG. 8 is a top plan view of the embodiment of the filter apparatus of FIG. 6 including an overlay printed circuit board;

FIG. 9 is a cross-section of the filter arrangement of FIG. 8, further including mounted shielding cans;

FIG. 10 is a graph showing representative insertion loss and return loss characteristics of an RF filter constructed in accordance with the principles of the invention.

FIG. 11 is a bottom plan view of an alternate embodiment of a filter and shielding apparatus constructed in accordance with the principles invention;

FIG. 12 is a graph showing representative insertion loss and return loss characteristics of an RF filter constructed using the alternate embodiment of FIG. 11.

### DETAILED DESCRIPTION OF THE PREFERRED EMBODIMENT

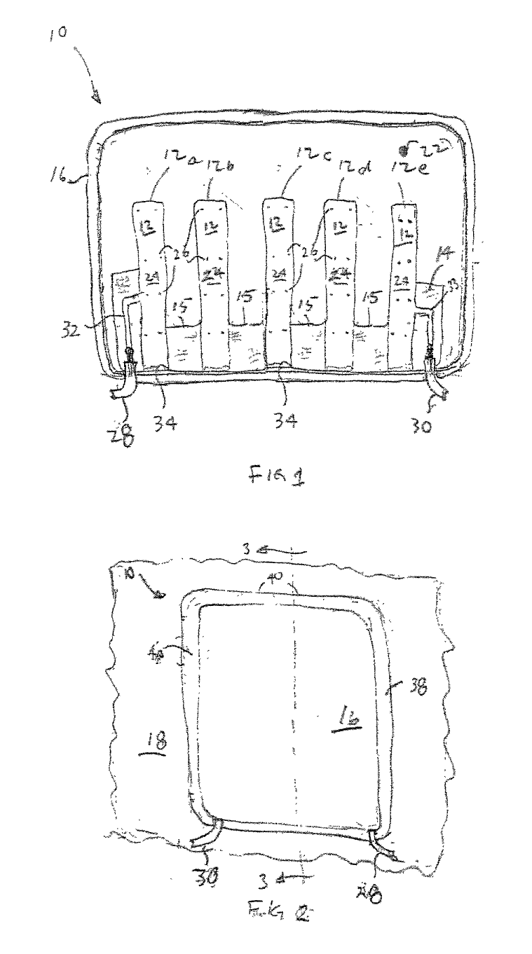

FIG. 1 shows a bottom plan view of an RF filter, designated generally by reference numeral 10, that is constructed in accordance with the principles of present invention. In the embodiment depicted in FIG. 1, the filter 10 is constructed with five radiator elements 12. It is not necessary for the structural features of each of the radiators to be identical. The radiator elements 12 are constructed from a printed circuit board (PCB) 14 material, where each side of the PCB is printed with a surface conductor 24. A printed circuit board with surface conductors on both sides is typically referred to as a double sided printed circuit board. The surface conductors 24 of the PCB 14 are configured to form an elongate conductor for each of the radiator elements 12. Preferably, a web 15 of the nonconductive PCB substrate material provides a structure to link and orient each radiator element 12 to the other. Generally, each of the radiator elements 12 will extend in a substantially parallel orientation or configuration to the other. A shielding enclosure, for example shielding can 16, encloses the radiator elements 12 to confine the RF electromagnetic radiation emanating from them to remain within the volume of the cavity formed by shielding can 16. In each radiator element 12, the surface conductor 24 on each side of the PCB is electrically coupled to the surface conductor on the other opposed side, for example, by a plurality of plated-through apertures 26. To couple each surface conductor to the other in this fashion, the apertures 26 are drilled through the PCB substrate 14 and a conductive material is deposited in each aperture to interconnect the surface conductors on each side of the PCB board.

For RF filter assemblies, it is necessary for each of the radiator elements 12 to couple radio frequency energy to the next adjacent radiator to pass the RF signal to be filtered from the signal input lead 28 to the signal output lead 30. In the RF filter depicted in FIG. 1, a plurality of radiator elements, namely five radiator elements 12 are depicted. Other radiator element counts may be used, for example, five or some other efficacious count. The signal from the input lead 28 is supplied to a first radiator element by means of an input tap line 32. An input tap line 32 connects the input lead 28 to a first radiator element 12a at a predetermined location along the length of the first radiator element 12a. The location of the input tap line relative to the base end 34 of the radiator element 12a affects the input impedance presented by input tap line 32. The input tap line location is selected in the filter design to provide a desired impedance match to the circuitry supplying the input signal to input lead 28. The base end 34 of each of the radiator elements 12 is grounded, for example, to shielding can 16, to complete the signal supply circuit of the filter that provides an input signal to the radiator element 12a on the input tap line 32. The presence of an input radio frequency signal on input supply line 28 causes an electromagnetic (EM) field to radiate from the radiator element 12a and extend into the space surrounding the radiator in accordance with principles of EM fields. The EM field emanating from each radiator will couple to the next adjacent radiator, that is, RF coupling is provided in the filter between radiators 12a, 12b, 12c, 12d and 12e. A shielding can 16 is connected to a ground plane conductor 18 to form a shielding enclosure, that is a conductive enclosure surrounding all of the radiators 12.

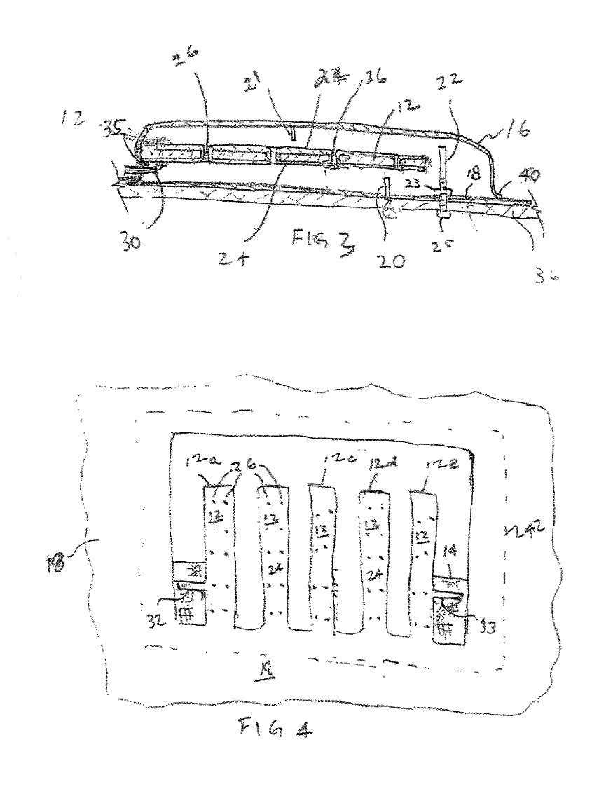

FIG. 2 shows a plan view of the filter apparatus of FIG. 1 from the opposite side to that shown in FIG. 1. The filter apparatus 10 is mounted on a ground plane 18. The signal to be filtered is supplied into the RF filter on input lead 28. The filtered output signal is provided on output lead 30. Shielding can 16 is affixed to a ground plane 18, preferably by soldering which provides both mechanical and electrical coupling. A skirt 40 may be provided to provide an ample structure to assist in affixing and coupling the shielding can 16 to the ground plane 18.

FIG. 3 is a cross-section of the RF filter of FIGS. 1 and 2 taken along the cutting line 3-3 of FIG. 2. The filter assembly includes a surrounding electrically conductive structure that is maintained at ground potential. In this embodiment of the RF filter, the surrounding shielding enclosure, is a conductive structure is comprised of a shielding can 16 and a ground plane 18 to which the shielding can 16 is mounted. Ground plane 18 is the conductive material on a surface of the PCB substrate 36. A radiator element 12 is shown in cross section in the figure and comprises a PCB structure having a surface conductor 24 on each of the opposed sides of the PCB as described previously with reference to FIG. 1. A plurality of apertures 26 are plated through to interconnect electrically the surface conductors 24 disposed on each side of the PCB formed into the radiator element. Each radiator element 12 is in spaced relation to the surrounding ground potential surfaces, which is achieved by attaching the radiator elements 12 to the shielding can 16 such that each radiator element is oriented substantially parallel to the planar surface of can 16 and the ground plane 18. Suitable means of attachment include soldering the conductive surface 24 of the radiator element to the shielding can 16. Soldering also provides the electrical connection to maintain one end of each of the radiator elements 12 at ground potential as well as providing the mechanical structure to maintain the orientation of the radiator elements 12 with respect to shielding can 16 and ground plane 18. For additional means to control filter tuning, conductive leads 20, 21 and 22 may be used. When such conductive leads are used, each extends from either ground surface 18 or shielding can 16 inwardly toward the central portion of the enclosure proximal to radiator elements 12.

Tuning of the filter is effected by variation of the filter elements, for example, by selection of a radiator shape and by the spacing configuration of the radiators to each other and to the surrounding grounded surfaces, most clearly shown in FIG. 3, namely, ground plane 18 and shielding can 16. Also, filter tuning is affected by the dimension and the placement of conductive leads 20, 21 and 22. When conductive leads are used, the conductive leads are connected at one end to ground potential, that is, connected either to the shielding can 16 or to the ground plane conductor 18. The other end of the conductive leads, the end opposed to the grounded end, extends inwardly toward the radiator elements 12 in the central portion of the cavity or volume of the grounded enclosure.

Each conductive lead element 20, 21 or 22 is preferably in the form of a wire to allow and the design specification of the items that affect EM coupling and filter behaviour by parameters such as: wire material, wire gauge, wire length and wire location. Also, these conductive lead elements may be constructed from a ferromagnetic material.

Thus, from the foregoing, the following factors can be varied to affect the tuning of the filter, that is:

(1) the dimension of the radiator elements 12,

(2) the spacing of the radiator elements from each other,

(3) the spacing of the radiator elements from the ground potential surfaces, that is, from the shielding can 16 and the opposed ground plane 18, and

(4) the presence, dimension and location of tuning element conductive leads 20, 21 and 22.

Examples of the conductive elements 20, 21 and 22 show locations where such conductive elements may be mounted in the shielding enclosure of this embodiment of the invention. The conductive elements may be of a fixed length and location, such as conductive elements 20 and 21 and the conductive elements may be attached to the shielding enclosure by soldering. The conductive elements may also be adjustable by providing suitable adjustment means. An example of a tuneable tuning element is conductive element 22 which is provided with a threaded body threaded into a nut 23. Naturally, a screw type threaded body of conductive element 22 threadingly engaging the passage through PCB 36 and ground plane 18 would eliminate the need to provide a separate nut. Tuning adjustment is effected by rotation of the exterior portion 25 of the conductive element which changes the length of conductive element 22 disposed in the interior volume of the shielding enclosure.

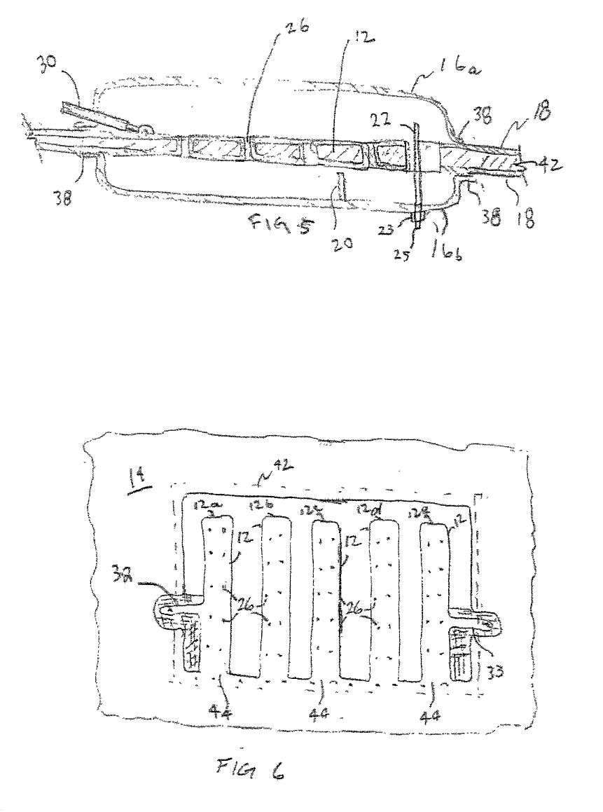

FIG. 4 is a plan view of an alternate embodiment of construction of a PCB RF filter apparatus in accordance with the principles of the invention. A double sided printed circuit board 42 is formed into each of the radiator elements 12 of the filter. In this embodiment of the RF filter, the surface conductor 24 of each radiator element 12 extends from the ground plane conductor 18 as, in this embodiment, the radiator elements and the ground plane 16 are constructed from a single piece of printed circuit board material. An input tap line 32 and an output tap line 33 extend from the outside radiator elements 12a and 12e. The footprint of the mounted shielding can is shown in ghost outline form 42 in the figure.

FIG. 5 is a cross-section of the embodiment of the RF filter construction of FIG. 4 showing the mounted shielding cans 16. One shielding can 16a is mounted on one side of the apparatus and the other shielding can 16b is mounted on the other side of the PCB 42 from which the radiator elements 12 are constructed. The PCB 42 has a plated surface conductor on both sides, which provides the ground surfaces 18 to which the shielding cans 16 are mounted. In this manner, the volume enclosed by the shielding cans 16a and 16b surrounds the radiator elements 12 and, consequently, the shielding cans enclose and contain the RF radiation emitted from the radiator elements 12. The shielding cans 16a and 16b are preferably solder mounted to the ground plane 18 on each respective side of the PCB 42 to provide electrical contact and a mechanical attachment of each shielding can 16 to the PCB board.

A variation of construction of a tuneable conductive element and 22 is shown in this embodiment. In this arrangement, the threaded nut 23 is shown mounted on the exterior of shielding can 16b.

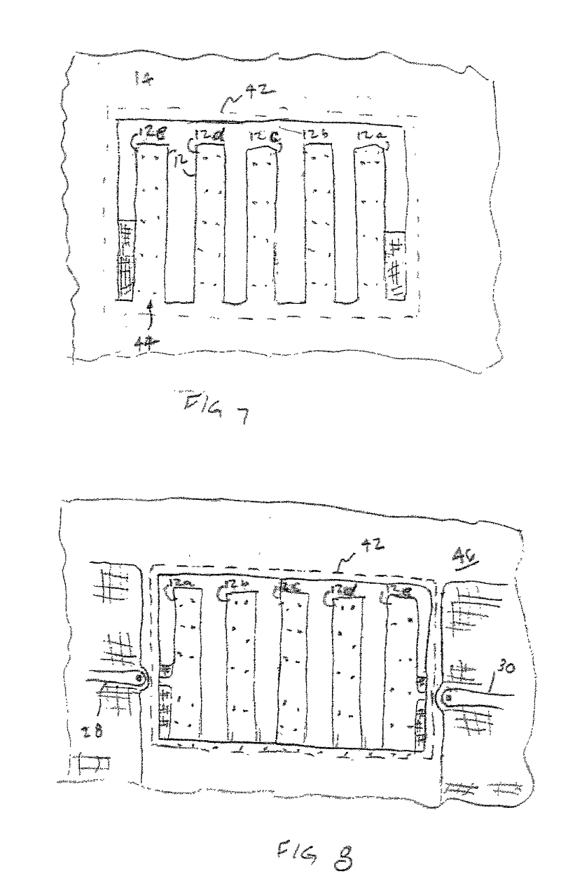

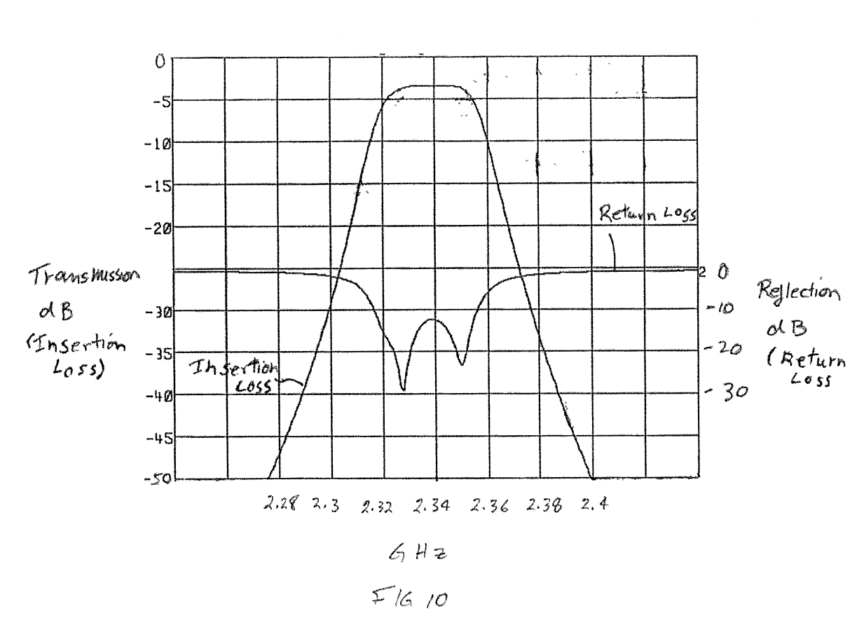

FIG. 6 shows a top plan view of an alternate embodiment of the RF filter apparatus of the present invention which employs a two board construction. In this embodiment, the radiator elements 12 are fabricated from a first double sided printed circuit board 14 by fabricating the printed circuit board material to form each of the radiators 12a, 12b, 12c, 12d and 12e. Similar to other embodiments, each radiator element has plated through apertures 26 interconnecting the conductors on each opposed side of the PCB forming the radiators 12. Also in this embodiment, the radiator elements 12 are formed from a single PCB board which also forms a surrounding ground plane 18. Consequently, the inter-radiator web 15 of FIG. 1 is not required in this embodiment. The input tap line 32 and output tap line 33 are etched into the printed circuit board at a predetermined distance from the base area 44 of the respective radiator 12a and 12e and one end of each tap line 32, 33 is connected to a corresponding radiator element. The other ends of the tap lines 32 and 33 extend outside of the shielding can mount footprint 42. That is, an end of each of input tap line 32 and output tap line 33 will extend outside of the mounted shielding can 16. Extension of the input tap line and output tap line 32 and 33 respectively to the exterior of the shielding can permits interconnection of the tap lines with the input and output leads exterior to the shielding can, as shown in FIGS. 8 and 9.

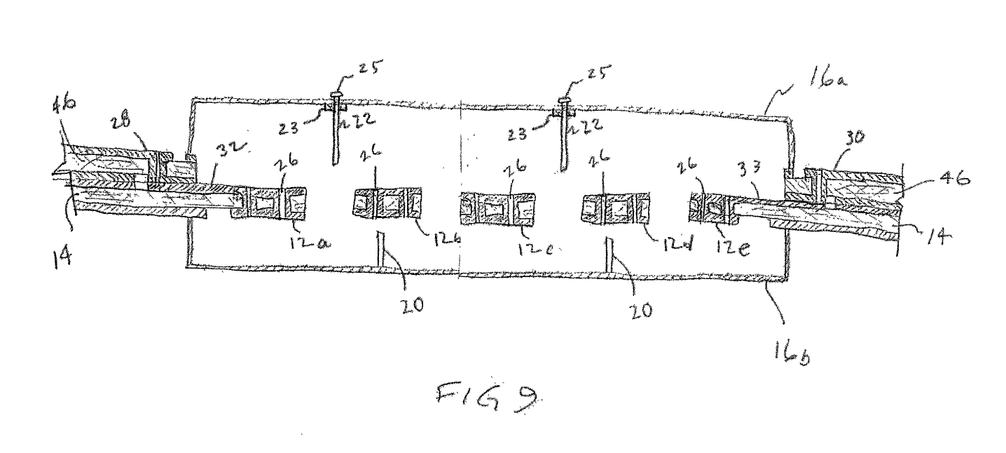

Construction of the radiator elements in accordance with the embodiment of the invention shown in FIGS. 6 and 7 uses a two board, or multi-layer PCB, arrangement to provide an input lead trace 28 exterior to the shielding can 16. Similarly, an output lead trace 30 is provided exterior to the shielding can 16. As will be describe in more detail subsequently, this embodiment of the invention permits installation of signal lead wires exterior to the shielding can and, consequently, enables the signal lead wires to be mounted before or after the shielding can is mounted.

FIG. 7 shows a bottom plan view of the structure of FIG. 6.

FIG. 8 shows an upper plan view corresponding to that of FIG. 6 and further includes a second PCB 46 mounted to the PCB of FIGS. 6 and 7.

As most clearly depicted in FIG. 9, the second PCB 46 is coupled to the upper surface of the PCB board 14 from which the radiator elements 12, shown in FIGS. 6 and 7, are constructed. The filter input lead 28 is interconnected with input tap line 32 to provide a signal path to radiator element 12a. The filtered signal arriving at radiator element 12e is carried by output tap line 33 to output lead 30. An upper shielding can 16a and a lower shielding can 16b are attached to the printed circuit boards 14 and 46 to provide an enclosure surrounding radiator elements 12 of the resonant filter structure. Ground leads 20, 22, may be attached to the shielding cans 16a or 16b to facilitate tuning of the filter.

FIG. 10 is a graph showing the electrical characteristics of an RF filter constructed in accordance with the principles of the invention. The RF filter provides a bandpass region centred around the 2.34 GHz frequency. Signal frequencies below the lower cut-off frequency at approximately 2.32 GHz roll off to approximately a 45 dB insertion loss at 2.28 GHz. The filter transmission frequency response characteristics or insertion loss above the upper cut-off frequency at approximately 2.35 GHz falls off more to −50 dB by approximately 2.4 GHz as depicted in the drawings.

Another filter characteristic shown in the graph is a trace of the filter signal reflection performance for given frequencies which is also known as the filter return loss. Return loss is a measure of the power transfer of a filter and the filter return loss trace in the figure shows peaks on either side of the filter bandpass, at approximately 2.33 GHz and 2.35 GHz. The graph of FIG. 10 is shown by way of illustration only of the characteristics of a filter constructed in accordance with the principles of the invention. Naturally, the frequency response characteristics of a filter constructed in accordance with the principles of the invention can be altered by changing the shape of the radiator elements and their location relative to each other and to the shielding can. As well, the shape, location and orientation of tuning conductive leads can be employed as previously described with reference to FIGS. 3 and 5 of the drawings.

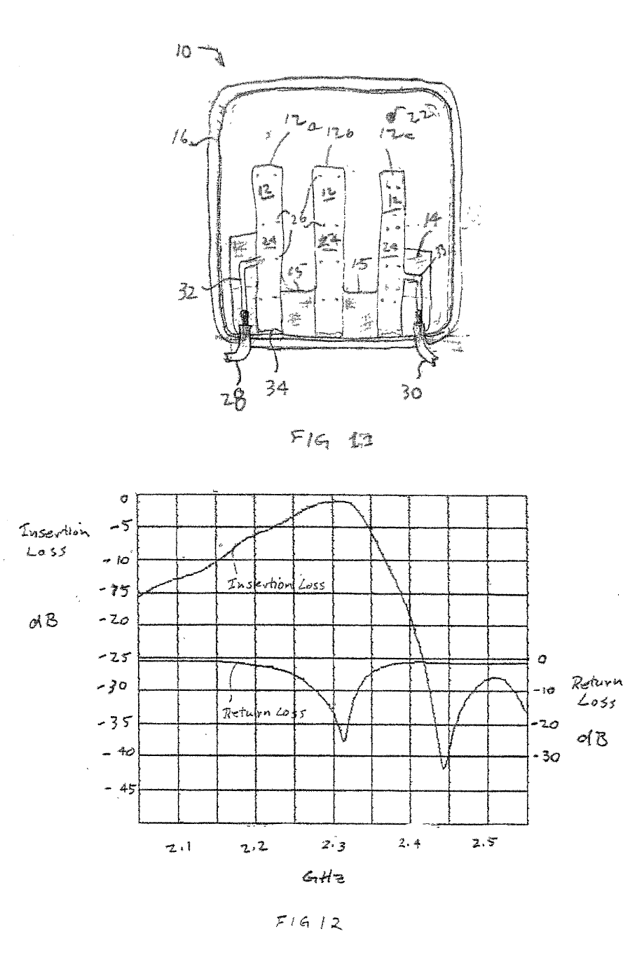

FIG. 11 shows a bottom plan view of an alternate embodiment of an RF filter, designated generally by reference numeral 10, that is constructed in accordance with the principles of present invention. In the embodiment depicted in FIG. 11, the filter 10 is constructed with three radiator elements 12. It is not necessary for the structural features of each of the radiators to be identical. The radiator elements 12 are constructed from a printed circuit board (PCB) 14 material, where each side of the PCB is printed with a surface conductor 24. A printed circuit board with surface conductors on both sides is typically referred to as a double sided printed circuit board. The surface conductors 24 of the PCB 14 are configured to form an elongate conductor for each of the radiator elements 12. Preferably, a web 15 of the non-conductive PCB substrate material provides a structure to link and orient each radiator element 12 to the other. Generally, each of the radiator elements 12 will extend in a substantially parallel orientation or configuration to the other. A shielding enclosure, for example shielding can 16, encloses the radiator elements 12 to confine the RF electromagnetic radiation emanating from them to remain within the volume of the cavity formed by shielding can 16. In each radiator element 12, the surface conductor 24 on each side of the PCB is electrically coupled to the surface conductor on the other opposed side, for example, by a plurality of plated-through apertures 26. To couple each surface conductor to the other in this fashion, the apertures 26 are drilled through the PCB substrate 14 and a conductive material is deposited in each aperture to interconnect the surface conductors on each side of the PCB board.

FIG. 12 is a graph showing the electrical characteristics of an RF filter constructed in accordance with the principles of the invention. The RF filter provides a bandpass region centred around the 2.3 GHz frequency. Signal frequencies below 2.3 GHz roll off to approximately a 15 dB insertion loss at 2.05 GHz. The insertion loss or frequency response above 2.3 GHz falls off more dramatically to a trough located at approximately 2.45 GHz as depicted in the drawings.

While the invention has been disclosed with reference to the particular embodiments disclosed in the description and drawings hereof, it will be apparent to those skilled in the art that many modifications and substitutions may be made to the specific embodiments herein described without departing from the spirit and scope of the invention as defined in the claims appended hereto.

I claim:

1. A radio frequency (RF) filter assembly comprising:
(i) a conductive RF shielding means bounding a volume;
(ii) at least two spacedly disposed elongate radiator elements disposed within the volume bounded by said conductive RF shielding means, each said elongate radiator element oriented in a common plane and substantially parallel to another, one end of each elongate radiator element being attached to said shielding means,
(iii) an input tap line connected at a predetermined input location to a first elongate radiator element disposed proximal to said conductive RF shielding means, the input tap line extending outwardly through to the exterior of said conductive RF shielding means; and
(iv) an output tap line connected at a predetermined output location to a second elongate radiator element disposed proximal to said conductive RF shielding means and remote from said first radiator element, the output tap line extending through to the exterior of said conductive RF shielding means.

2. The apparatus of claim 1 further including at least one tuning means.

3. The apparatus of claim 2 wherein said tuning means further includes tuning adjustment means.

4. The apparatus of claim 2 wherein said tuning means comprises at least one conductive lead extending from said conductive RF shielding means inwardly into the volume bounded by said conductive RF shielding means.

5. The apparatus of claim 2 wherein said tuning means further includes tuning adjustment means.

6. The apparatus of claim 5 wherein said tuning adjustment means is operable to change the length of the conductive lead extending from said conductive RF shielding means inwardly into the volume bounded thereby.

7. The apparatus of claim 5 wherein said tuning adjustment means is operable to change the position of the conductive lead extending from said conductive RF shielding means in relation to an elongate radiator element disposed within the volume bounded by said conductive RF shielding means.

8. The apparatus of claims 5 wherein said tuning adjustment means comprises threading engagement of said conductive lead in relation to said conductive RF shielding means, the tuning adjustment means operable from the outside of said conductive RF shielding means.

9. The apparatus of claims 6 wherein said tuning adjustment means comprises IQ threading engagement of said conductive lead in relation to said conductive RF shielding means, the tuning adjustment means operable from the outside of said conductive RF shielding means.

10. The apparatus of claims 7 wherein said tuning adjustment means comprises threading engagement of said conductive lead in relation to said conductive RF shielding means, the tuning adjustment means operable from the outside of said conductive RF shielding means.

11. A radio frequency (RF) filter assembly comprising:
(i) at least two spacedly disposed elongate radiator elements formed from double sided PCB material,
(ii) means to electrically interconnect each side of said radiator double sided PCB material;
(iii) shielding means bounding a volume containing all said elongate radiator elements;
(iv) spacing means to maintain the spaced disposition of each said elongate radiator element to the other and to said shielding means;
(v) conductor means interconnecting an end of each elongate radiator element to said conductive RF shielding means;
(vi) an input tap line connected to a first radiator element at a predetermined input location and extending outwardly through to the exterior of said conductive RF shielding means;
(vii) an output tap line connected to a second radiator element remote from said first radiator element at a predetermined output location, the output tap line extending through to the exterior of said conductive RF shielding means.

12. The apparatus of claim 11 further including at least one tuning means.

13. The apparatus of claim 12 wherein said tuning means further includes tuning adjustment means.

14. The apparatus of claim 12 wherein said tuning means comprises at least one conductive lead extending from said shielding means inwardly into the volume bounded thereby.

15. The apparatus of claim 12 wherein said tuning means further includes tuning adjustment means.

16. The apparatus of claim 15 wherein said tuning adjustment means is operable to change the length of the conductive lead extending from said shielding means inwardly into the volume bounded thereby.

17. The apparatus of claims 15 wherein said tuning adjustment means comprises a nut mounted on said shielding means threadingly engaging said conductive lead.

18. The apparatus of claims 1 wherein said tuning adjustment means comprises a nut mounted on said shielding means threadingly engaging said conductive lead.
